(19) United States
(12) Patent Application Publication
(10) Pub. No.: US 2006/0057032 A1
(43) Pub. Date: Mar. 16, 2006

(54) Substrate plate, method and apparatus for manufacturing such a substrate plate, and system for conducting biossays comprising such a substrate plate

(76) Inventors: Herman Jacobus Blok, Retie (BE); Marinus Gerardus Johannes Van Beuningen, Oss (NL)

Correspondence Address: AMSTER, ROTHSTEIN & EBENSTEIN LLP, 90 PARK AVENUE, NEW YORK, NY, 10016, US

(21) Appl. No.: 10/511,922

(22) PCT Filed: Apr. 17, 2003
(86) PCT No.: PCT/EP03/50114

§ 371 Date: Jul. 23, 2005

(30) Foreign Application Priority Data
Apr. 19, 2002 (EP) 02076728.1

(51) Int. Cl. B01L 9/00

(52) U.S. Cl. 422/102

(57) ABSTRACT

A substrate plate comprises a microplate (1) made of a plastic material, having an array of wells (2) arranged in rows and columns, the bottom of at least one well (2) being provided by a porous substrate (3). Each porous substrate (3) is incorporated into the well (2) by means of a thermal bond.

The invention relates to a substrate plate, comprising a microplate made of a plastic material, having an array of wells arranged in rows and columns, the bottom of at least one well being provided by a porous substrate.

The invention further relates to a method of manufacturing such a substrate plate.

The invention also relates to a system for conducting bioassays, comprising a substrate plate with a number of wells, and an incubation device for holding the plate.

The invention also relates to an apparatus for manufacturing such a substrate plate.

Examples of such a substrate plate, method, system and apparatus are known generally in the field. One of the primary uses is for conducting automated high-throughput bioassays. For this purpose, channels in at least one area of the surface of the substrate are provided with a first binding substance capable of binding with an analyte. Reagents used in these bioassays are immobilized in the channels and a sample fluid is forced through the channels to be contacted with the reagents. An analyte present in the sample reacts with one of the binding substances. In general, the analytes or binding substances are tagged with an optically active compound, of which the fluorescence or luminescence is increased during the reaction between analyte and binding substance, for example. A qualitative and/or quantitative analysis of the composition of the sample fluid can thus be carried out by illuminating and optically scanning the contents of the wells.

In the known system, the microplate is glued to the substrate. This has the disadvantage that the glue can creep over time, especially if the substrate plate is incubated, which involves an increase in temperature. Glue can thus cause contamination of the bioassays by entering the well. Depending on the intended use of the substrate plate, an adverse consequence can be that the glue influences optical measurements in an uncontrollable manner, as the glues used are often autofluorescent. Additionally, the possibility of contamination of the surroundings of the substrate plate, in particular of handling mechanisms in an automated high-throughput system for conducting bioassays, exists, making the substrate plates less suitable for use in such systems. In order to manufacture such a glued substrate plate, it is therefore necessary to apply the glue with great care, making manufacturing difficult and thus expensive.

It is an object of the present invention to provide a substrate plate of the type mentioned above, which is easier to manufacture, whilst meeting the requirement of minimal contamination.

This object is achieved by the substrate plate according to the invention, which is characterised in that each porous substrate is incorporated into the well by means of a thermal bond.

Because a thermal bond is used, no extra materials with unknown properties need be used. Thus, materials handling during manufacturing is made easier. Furthermore, contamination by other materials is not possible, thus, for example, eliminating the possibility of influencing optical measurements. Also, creep is not an issue, since for bioassays a microplate material is selected that is able to withstand the temperatures involved in incubation.

Preferably, the porous substrates comprise oriented flow-through channels.

It is believed that this property increases the strength of the bond, as the oriented flow-through channels exhibit an increased capillary force, so that molten plastic of the microplate is sucked deeper into the porous substrate.

In a preferred embodiment of the substrate plate, each well is formed in a discrete protrusion, projecting from one face of the microplate, a separate porous substrate being bonded to the distal end of each protrusion facing away from the face, in such a manner that the porous substrates are spaced apart from each other.

Thus, when fluid is deposited in the well and flows through the substrate to the side of the substrate facing away from the well, the fluid cannot creep across the surface of the substrate plate to a substrate section forming the bottom of another well. Therefore, cross-contamination between wells is avoided.

According to another aspect of the invention, there is provided a method of manufacturing a substrate plate according to the invention, comprising heating the porous substrates and bringing the microplate and the porous substrates into contact with each other.

This method has the advantage of being easy to implement, when compared with other types of thermal bonding. As each substrate is heated, either in its entirety or locally, and then brought into contact with the microplate, bonds are only formed at the points of contact. This eliminates the need for precisely heating the microplate at those locations where a bond is to be formed.

A preferred embodiment of the invention comprising supplying heat to the porous substrates whilst the microplate is in contact with the porous substrates, preferably supplying heat to the porous substrates whilst the microplate is in contact with the porous substrates, preferably pressing the microplate and the porous substrates against each other, and preferably also cooling the porous substrates whilst pressing the microplate and the porous substrates against each other

It has been found that this increases the strength of the bond between the microplate and the porous substrates.

In a preferred embodiment, the method comprises arranging a plurality of porous substrates in an array of rows and columns, corresponding substantially to at least part of the array of rows and columns in which the wells in the microplate are arranged, bringing the microplate and array of porous substrates into alignment in such a manner that each porous substrate is aligned opposite the bottom of a well, and bringing the microplate into contact with the porous substrates in such a manner that each porous substrate closes off the bottom of one well.

This embodiment has the advantage that quality assessment and control of the porous substrate pieces can be done offline and prior to use. Moreover, excess substrate material not located at the bottom of a well does not need to be removed in this case. Also, it has been demonstrated that removing excess substrate material protruding over the wells can give rise to uneven edges of the bonded substrate areas around the wells. This is avoided when pre-cut porous substrates are brought into alignment with the microplate.

A preferred embodiment of the method according to the invention comprises bonding a microplate in which each well is formed in one of an array of spaced protrusions, arranged in rows and columns and projecting from one face of the microplate, wherein each porous substrate is bonded to the distal end of each protrusion facing away from the face, the method comprising mounting the microplate in a guide, adapted to envelope at least parts of side walls connecting the face to the distal end of a corresponding one of the protrusions, such that at least part of a protrusion is supported by the guide.

Preferably, the method also comprises pressing the microplate against the porous substrates by applying a support against the microplate, comprising an array of support protrusions arranged in rows and columns and corresponding substantially to the array of wells, each support protrusion being shaped to engagingly fit inside the well, such that walls of each well are supported from inside the well by the support protrusions, when inserted into the wells.

The features of the two embodiments recited above, help to prevent buckling of the walls of the wells when the microplate and heated substrate are brought into contact.

According to another aspect of the invention, there is provided a system for conducting bioassays, comprising a substrate plate with a number of wells, and an incubation device for holding the plate, characterised in that the substrate plate comprises a microplate with an array of wells arranged in rows and columns, wherein the bottom of each well is a porous microarray substrate, wherein the incubation device comprises an incubation chamber for holding the microplate and a cover for sealing the incubation chamber, said incubation device having a heat block with an array of openings, each opening adapted to receive a well of the microplate, wherein a sealing gasket is provided for individually sealing each well of the microplate, and in that the system comprises a substrate plate according to the invention, or a substrate plate manufactured by means of a method according to the invention.

In this manner a system is obtained with a microplate with wells that can be made according to an SBS standard format allowing the use of standard screening instrumentation, especially in automated robotic platforms. Using for example a microplate with an array of ninety-six wells allows a parallel processing of a large number of microarrays resulting in a very efficient high throughput screening. Because the microplate is thermally welded to the substrate, no contamination of the robotic system by glue is possible. Also, only substrate and microplate materials are used, simplifying the optical analysis, as these two materials can be selected to have favourable, known optical properties.

According to a further aspect of the invention, there is provided an apparatus for manufacturing a substrate plate according to the invention, comprising a heating device for heating the porous substrates and a press for pressing the microplate and the porous substrates against each other.

This apparatus is advantageously used to carry out the method according to the invention.

The invention will now be described in further detail with reference to the accompanying drawings, of which:

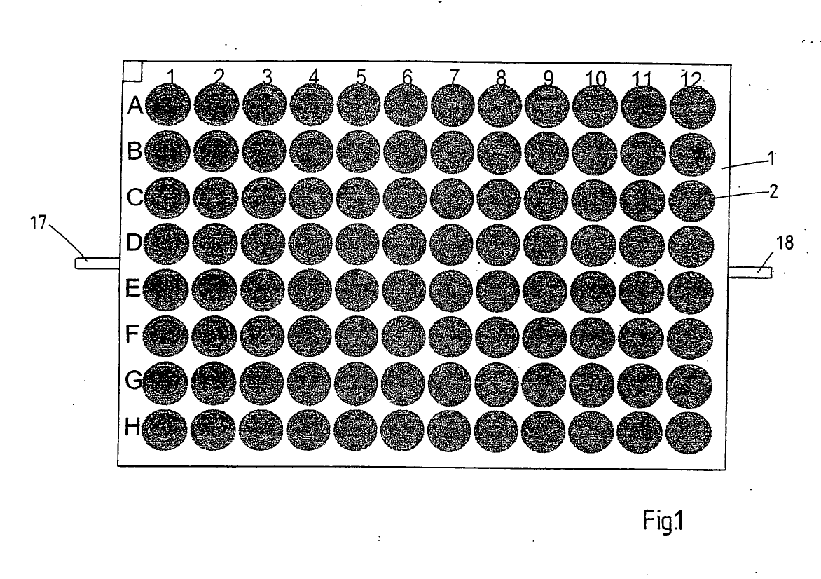

FIG. 1 shows a top view of an embodiment of the system according to the invention;

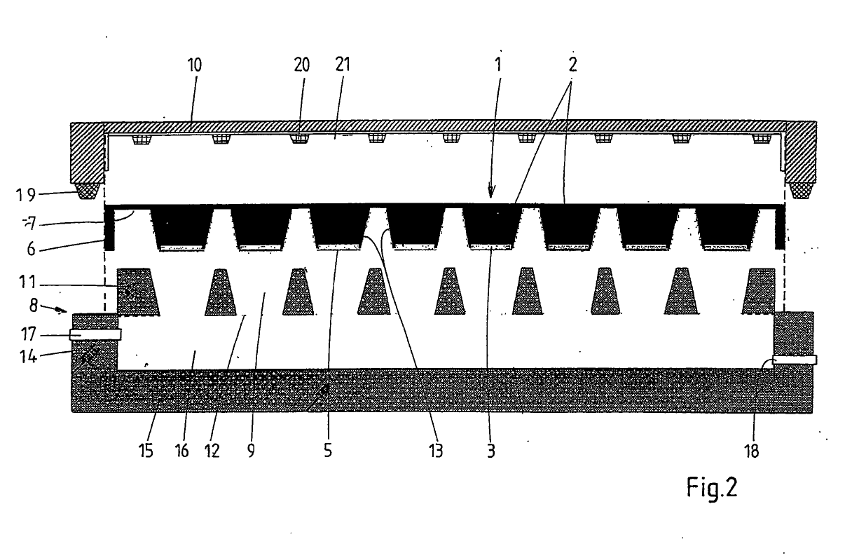

FIG. 2 shows a side view of the system of FIG. 1, wherein the incubation device, the cover and the microplate are separately shown;

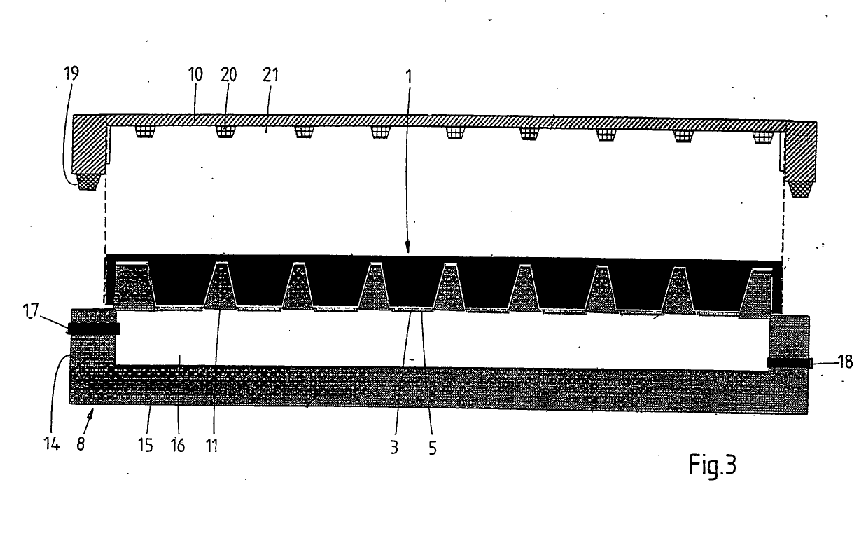

FIG. 3 shows a side view of FIG. 1, wherein the wells of the microplate are located within the openings of the heat block of the incubation chamber;

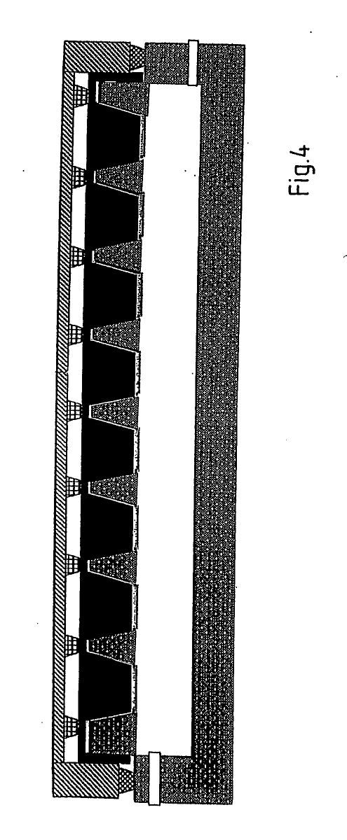

FIG. 4 is a side view of the system of FIG. 1, wherein the cover is in its closed position;

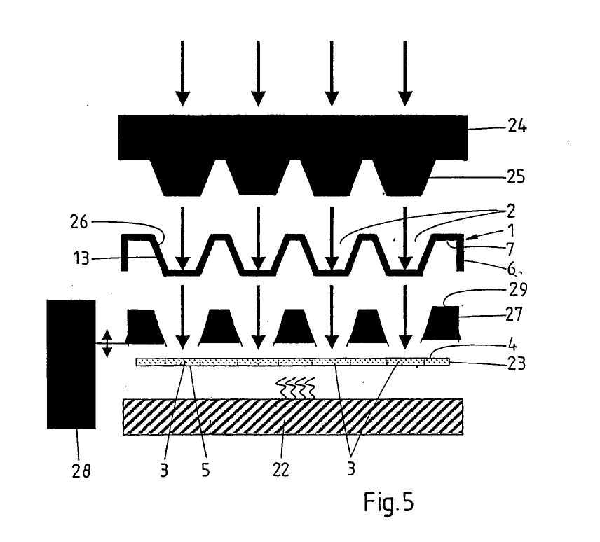

FIG. 5 is a schematic diagram illustrating a method of manufacturing the substrate plate; and

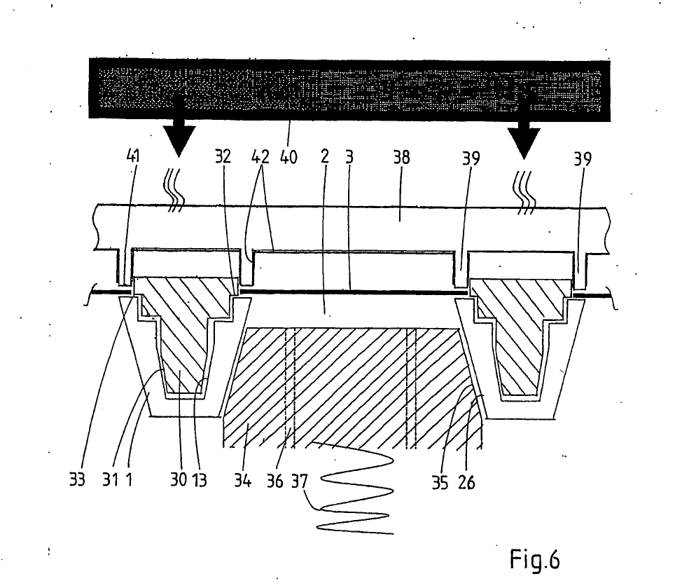

FIG. 6 is a schematic diagram illustrating an alternative method of manufacturing the substrate plate.

Referring to the drawings, there is shown a system for performing bioassays, preferably high throughput screening tests. The system comprises a microplate 1 as substrate plate, the microplate 1 having an array of wells 2 arranged in rows and columns, as can be seen in FIG. 1. In the embodiment shown, the microplate comprises ninety-six wells arranged in eight rows and twelve columns. Of course other array arrangements are possible, for example with 8, 12, 24, 48, 384 or 1536 wells. As schematically shown in the side views of the system of FIGS. 2-4, the bottom of each well 2 is provided by a microarray substrate 3. The substrates 3 are located substantially in the same virtual plane.

In this embodiment, each substrate is made of a porous flow-through metal oxide membrane. Possible examples are zinc oxide, zirconium oxide, tin oxide, tantalum, titanium and alloys of metals and doped metals. Alternatively, the substrates 3 could be made of silicon oxide, in which holes or channels have been made using an ion-etching technique. Glass is also a possibility, as is cellulose. If the system is to be used for filtration only, then PTFE (Teflon®) is a preferred material for the substrates 3. However, for use in bioassays as described here, the substrate is preferably an aluminium oxide having a large number of through-going channels oriented mainly perpendicular to the upper and lower surfaces 4 and 5 (see FIG. 5) respectively, of the substrate. Preferably, the channels are capillary channels. In a practical embodiment of the substrate, the internal diameter d of the substrate can be 5 mm, wherein the channels may have a spacing of approximately 150-200 nm. A binding substance can be bound to the substrate in groups of channels at a spacing of 200 μm. Such a group of channels can be indicated as a spot or spot are. Each substrate 3 may have 300-400 spots or more. For a further description of the substrate material, reference is made to the above-mentioned international patent application WO 01/19517. It will be understood that the number of wells, the number of spots and the dimensions are mentioned by way of example only and may be varied as desired. Although the system is especially suited to performing bioassays, and will be described hereinafter in an embodiment adapted for that use, the system, and in particular the substrate plate comprised of the microplate 1 and substrates 3 is also suitable for filtration of sample fluids only, without any binding substances being present or with a binding substance on its surface for generic binding of sample components such as binding of mRNA, rRNA.

In a preferred embodiment, the wells 2 have a conical shape as shown in the drawings. However, the wells 2 may have a different shape. The conical shape of the wells 2 optimises the imaging characteristics of the microplate 1, i.e. reduction of scattering and reflection of light and enablement of darkfield imaging. The microplate has a skirt 6, wherein the lower side of the skirt 6 is located in the same virtual plane as the substrates 3 or is located at a higher level. Such dimensions of the skirt 6 allow an on-the-fly spotting of the substrates 3 of the microplate 1. The microplate is made of a suitable plastic material, e.g. LCP, TOPAS® or polypropylene. In particular, TOPAS®, a cyclic olefin copolymer available from TICONA is preferred, due to its superior capacity for bonding to metal oxides, in particular to aluminium oxide substrates. In the preferred embodiment, a grade of TOPAS® selected from the group comprising TOPAS 5013, 6013, 6015 is used, wherein TOPAS® grade 6015 is most preferred. The latter grade is preferred because it bonds best to aluminium oxide substrates 3. In particular the bond exhibits the smallest tendency to reverse. Additionally, this grade is less brittle than the other materials mentioned, making handling easier, as there is a reduced tendency for pieces to chip off. In any case, the material used must be chemically resistant and heat resistant up to 120° C., robot compatible, optically compatible, i.e. flat and exhibit minimal autofluorescence. Further, the material should have minimal binding properties for labelled bio-molecules. All of the mentioned grades of TOPAS® exhibit these good heat-resistant and optical properties. Preferably, the microplate material is black to minimise autofluorescence and refractive back scattering of light. As an alternative, it is possible to provide the microplate 1 with a coating to obtain the desired non-reflective properties.

The substrates 3 are incorporated into the wells 2 by thermal bonding, using the method according to the invention. The substrates 3 are flat and are preferably located in the same virtual plane, i.e. are parallel to a virtual plane within a distance less than 100 μm. This has the advantage that it is easier to focus the optical system used to measure the binding of analytes to binding substances. Because each well 2 is formed in a discrete protrusion, projecting from a lower face 7 of the microplate 1, and because a separate substrate is bonded to the distal end of each protrusion facing away from the lower face 7 in such a manner that the substrates 3 are spaced apart from the each other, a drop of fluid sample attached to the lower surface 5 of one of the substrates 3 cannot creep across to the lower surface 5 of another one of the substrates 3. The substrates 3 are isolated from one another, thus preventing cross-contamination between the contents of the wells 2.

The system further comprises an incubation device 8, providing an incubation chamber 9 for holding the microplate 1 and a cover 10 for sealing the incubation chamber 9. The incubation device 8 has a heat block 11 with an array of openings 12, each opening having a conical shape corresponding to the shape of the wells 2. The conical shape of the wells 2 provides a self-centring effect during positioning of the microplate 1 in the incubation device 8. The maximum thickness of the heat block 11 corresponds with the depth of the wells 2 of the microplate 1. In this manner, the substrates 3 of the wells 2 are either projecting out of the heat block or aligned flush with the lower surface of the heat block 11. Thereby, a sample fluid attached to the lower surface 5 of a substrate 3 cannot contaminate the heat block 11.

Each well is received within an opening 12, so that an outer wall 13 of a well 2 of the microplate 1 is fitted within the inner wall of a corresponding opening 9. In this manner, an optimum heat transfer from the heat block 11 to the wells 2 is obtained.

The incubation device 8 has a circumferential wall 14 and a bottom wall 15, wherein the heat block 11, the circumferential wall 14 and the bottom wall 15 enclose an air chamber 16 having a connection 17 for an external vacuum/pressure system, not shown. Further the air chamber 16 has a drain connection 18. The drain connection 18 can be closed by means of a valve, not shown.

The incubation device is preferably made of a metal and is provided with a heating element to control the temperature of the incubation chamber and thereby of sample fluids provided in the wells 2 of a microplate 1 received in the incubation chamber. The heating element can be made as a heating block containing one or more Peltier elements. As an alternative, heat may be transferred to the incubation chamber via a water bath.

As shown in FIGS. 2-4, a sealing gasket 19 is provided on the lower side of the circumferential wall of the cover 10. As an alternative, the gasket could be provided on the upper side of the circumferential wall 14 of the incubation device 8. This sealing gasket 19 seals the incubation device 8 when the cover 10 is in the closed position of FIG. 4. The air chamber 16 is then closed in an airtight manner. A further sealing gasket 20 is provided, having circular openings 21 with a diameter corresponding to the diameter of the openings 12 at the surface of the heat block 11. Preferably, the sealing gasket is sealingly fixed on the inner side of the cover 10. When the cover is in its closed position, the gasket 20 sealingly engages the upper side of the microplate 1. In view of the shape of the sealing gasket 20, each well 2 of the microplate is individually sealed with respect to the other wells 2 and the environment.

The cover 10 is preferably transparent and is made of glass, for example. The cover 10 can be provided with a heating element, for example by incorporating transparent electrical wires in the cover material. As an alternative, a heating element having the same shape as the heat block 11 could be used for heating the cover. The cover 10 can be heated in this manner to prevent condensation during conducting a high throughput screening test. The transparency of the cover allows a real time measurement to be made from above using a CCD system or a suitable optical scanner.

During operation, the pressure in the incubation device can be controlled by a vacuum/pressure system connected to the connection 17. To perform high throughput screening bioassays, one or more sample fluids are provided in the wells 2 and the microplate 1 is inserted into the incubation chamber 9. The cover 10 is brought in its closed position, as shown in FIG. 4, and the pressure within the air chamber 16 is controlled. A low pressure in the chamber 16 creates a pressure difference over the substrates 3, whereby the sample fluid is forced through the channels of the substrate 3, thereby creating a low pressure within the wells 2. By removing the low pressure in the chamber 16, the sample fluid is automatically forced back through the channels of the substrates 3 into the wells 2. Of course, it is possible to create a high pressure in the chamber 16 to force the sample fluid through the channels into the wells 2 more rapidly. By alternatingly creating a low pressure in the chamber 16 and removing the low pressure, the sample fluids are forced through the channels of the substrate a number of times. The individual sealing of each of the wells 2 shows the advantage that a malfunction of one of the substrates 3, which prevents the creation of a pressure difference over the substrate, will not prevent normal use of the other substrates 3.

The imaging of the bioassay is done from above through the transparent cover 10 using a CCD camera, for example. This allows a real time kinetic measurement. The height h of the chamber 16 is such that a standard microplate with a corresponding array of wells can be located in the chamber 16 to collect filtrate from the microplate 1. The chamber 16 can further be used as a humidifying chamber by releasing a small amount of liquid in the chamber. Thereby, evaporation of sample liquid is significantly reduced at elevated temperatures and during extended operations. Flow-through washing of the substrates 3 is possible. The drain connection 18 allows the disposal of the washing liquids.

Preferably, a microplate 1 is used meeting the standard format as proposed by the Society for Biomolecular Screening (SBS) for microplates. This allows the use of current industry standards for screening applications and screening instrumentation, especially the use of automated robotic platforms. In this manner, the system as described can be used in expression profiling, proteomics, ELISA-based bioassays, receptor-ligand binding bioassays and enzyme kinetic bioassays.

It will be understood that the system of the invention allows parallel processing of a large number of microarrays. A sequential fluorescent detection of the microarrays by imaging per well is facilitated by the flatness and location of the substrates 3 in the same virtual plane. Further, the dimensions of the wells, in particular the conical shape of the wells, allow the sequential fluorescent detection. The system is adapted to automation and is robot compatible. The individual sealing of the wells shows the advantage that in case of substrate breakage, there is no interference of the control of the pressure variation at the other substrates. The microplate 1 allows for an on the fly spotting of the binding agents.

In principle, any type of thermal welding may be used to bond the substrates 3 to the microplate 1. This includes the use of lasers, or embedded heating wires. In a variant using laser welding, bonding and cutting of the substrate material into individual substrates 3 occur simultaneously. In such a variant, the microplate material is preferably (locally) coloured with a black dye, to absorb the transmitted heat from the laser, which is applied during cutting. This results in very local melting of the microplate material at the contact area of the substrates 3 and the microplate 1. The advantage of this method is that it is relatively simple, requiring no heating surfaces and little in the way of pre-alignment of the substrates 3 relative to the microplate.

Another simple and effective way of manufacturing the substrate plate comprising the thermoplastic microplate 1 and substrates 3 is demonstrated in FIG. 5. There is shown a cross-sectional diagram of the substrate plate and selected parts of an automated apparatus for manufacturing the substrate plate. The apparatus comprises a heating device, including a heating plate 22.

Several variants of the method are possible. In one variant, a plurality of porous substrates 3 are arranged in an array of rows and columns, corresponding substantially to at least part of the array of rows and columns in which the wells 2 in the microplate 1 are arranged, on top of the heating plate 22. In an automated variant of the method, the substrates 3 are individually aligned and positioned using a suitably controlled pick and place robot. The term corresponding means that the substrates 3 are substantially centred on the wells 2 in a direction perpendicular to a virtual plane in which the substrates 3 are located. This embodiment of the manufacturing method has the advantage that each individual substrate can be checked for defects before being placed onto the heating plate 22. Thus, it is known before manufacturing of the substrate plate that each substrate 3 is in order. Additionally, the substrate plate is finished after bonding. No tooling of the substrates 3, for example to remove excess material, is required.

Alternatively, as is shown in FIG. 5, it is possible to provide a discrete sheet 23 of substrate material, i.e. porous aluminium oxide in this example, which sheet is placed on the heating plate 22. In one advantageous variant, the substrates 3 are comprised in the sheet 23 in the form of pre-perforated disks, arranged in an array of rows and columns, corresponding substantially to at least part of the array of rows and columns in which the wells 2 are arranged. After bonding, the porous substrate material interconnecting the porous substrates 3 is removed, so that the substrates incorporated into the finished substrate plate are spaced apart, thus, as mentioned, preventing cross-contamination between sample fluids inserted into the different wells 2 during later use. The sheet 23 need not necessarily be pre-perforated. If it isn't, the method of manufacturing the substrate plate will further include the step of removing the porous substrate material interconnecting the porous substrates 3 by cutting, e.g. by laser cutting, using an appropriately controlled cutting tool. A variant of the method using one single sheet 23 has the advantage of increased ease and speed of handling and of being more amenable to robotic automation.

The heating plate 22 provides heat to the substrates 3 through direct contact with the lower surfaces 5 of the substrates, i.e. the surface facing away from the microplate 1. Thus, the microplate is only heated indirectly, namely at the sites of contact with the substrates 3. This decreases the risk of deforming other parts of the microplate, which would be the case if the microplate weren't to be heated indirectly. Additional heat is supplied through the air in the pores of the substrates 3, which is useful as the substrate material itself is not a very good conductor of heat. The substrates are heated to just above the melting temperature of the microplate plastic used.

The apparatus for manufacturing the substrate plate comprises a press comprising a stamp 24, by means of which the microplate is pressed against the substrates 3 or the sheet 22 comprising the substrates 3. Preferably, the stamp 24 presses the microplate 1 against the substrates 3 whilst heat is supplied to the substrates 3. This ensures a better bond, because the molten microplate material is pressed into the pores of the substrates 3. Additionally, this ensure a better melting of the microplate material than if the substrates 3 were only heated before bringing them into contact with the microplate, as part of the heat transfer is by conduction of heat by the air in the pores of the substrates 3.

Preferably, the pressure is maintained whilst the substrates 3 and microplate 1 cool, i.e. the porous substrates are cooled whilst pressing the microplate and the porous substrate against each other. It has been found that by maintaining pressure between the microplate 1 and the substrates 3 during all the phase changes of the microplate material the strongest bond is achieved. A method of cooling whereby the rate at which heat is supplied via the heating plate 22 is slowly decreased in a controlled manner is preferred. This helps to prevent loosening of the bond due to sudden shrinkage of either the substrates 3 or the microplate 1. To implement this method, an automated apparatus for manufacturing the substrate plate comprises a controller for decreasing the rate at which heat is supplied to the porous substrates 3 in a controlled manner.

The method according to the invention has been successfully used to bond microplates of TOPAS® 5013, 6013 and 6015 to aluminium oxide substrates. A good bond was achieved for TOPAS® 5013 by maintaining a pressure of 1177 mbar at a heating temperature of the substrates 3 of 135° C. during a period of three minutes. The plastic was cooled down for three minutes before the pressure was released. A good bond was achieved for TOPAS® 6013 by maintaining the same pressure of 1177 mbar at a heating temperature of the substrates of 140° C. for three minutes, again maintaining the pressure for three minutes during cooling. For TOPAS® 6015, good results were achieved by bonding for three minutes at a heating temperature of 165° C. at 1177 mbar. Again the pressure was maintained for three minutes during cooling of the microplate 1. The last-described variant is currently believed to represent the best mode of putting the invention into practice. Of course, the pressure used may be varied within the scope of the invention, but should preferably exceed 70 mbar. Due to the use of a guidance mechanism in the present invention, there is no strict upper limit to the amount of pressure applied, as will be explained below. The amount of time for which heat is applied can vary from 1 to about 10 minutes, but is preferably between 2 and 7 minutes, in order to ensure a good bond without too much deformation of the microplate 1.

Hitherto, it has been believed that thermal bonding of a thermoplastic microplate to the types of substrates used in bioassays was not possible, due to deformation of the microplate. The invention has proved this prejudice wrong by the choice of materials and the manner in which manufacture of the substrate plate is performed. A set of further measures reduces the tolerance range of the dimensions of the substrate plate.

The stamp 24 shown in FIG. 5 comprises a plurality of protrusions 25 arranged in rows and columns and corresponding substantially to the array of wells, i.e. being aligned such that they are substantially centred on the wells 2 in a direction perpendicular to a virtual plane in which the substrates 3 are located when the group of substrates 3 or sheet 23 is correctly aligned relative to the stamp 24. This latter alignment is ensured by means of a guidance mechanism in the apparatus. Each stamp protrusion 25 has a frusto-conical shape, corresponding to the inside of each of the wells 2. Thus, the stamp protrusions 25 are shaped to engagingly fit inside the wells 2, engaging inner walls 26 of the wells 2. In other words, the stamp protrusions 25 are shaped to engagingly fit inside the wells 2, such that walls of each well are supported from inside the well by the stamp protrusions 25, when inserted into the wells. By means of the stamp protrusions 25, buckling of the walls forming the wells 2 when the microplate 1 and substrates 3 are pressed together is prevented. Additionally, the wells cannot crimp laterally during cooling, because the stamp 24 is kept pressed down during cooling. This helps maintain the bond during cooling, by preventing shear stresses.

Preferably, the outer walls 13 of the wells 2 are also supported during pressing and cooling. This is achieved by means of a guide 27, adapted to envelope at least parts of side walls connecting the lower face 7 of the microplate 1 to the distal ends of the wells 2 to which the substrates 3 are bonded. In fact, the guide 27 comprises openings similar in shape to the openings 12 in the heating block, into which the wells 2 are received.

By supporting both the inner walls 26 and the outer walls 13 of the wells 2, it is also ensured that the wells 2 retain a pre-defined shape, adapted so that the wells 2 fit snugly into the openings 12 of the heating block.

Besides functioning as a support for the outer walls 13 of the wells 2, the guide 27, in combination with a height adjustment mechanism 28, functions as a means for limiting the movement of the stamp 24 in the direction of pressing to a pre-determined distance from the substrates 3. In the example shown, a top face 29 of the guide 27 contacts the lower face 7 of the microplate 1, when the stamp 24 presses the microplate down onto the substrates 3. The height adjustment mechanism 28, together with the dimensions of the guide, determines how far the stamp 24 and microplate 1 can be pressed down. In this manner, the depth of each well 2 can be precisely determined. This has the advantage of making the finished substrate plate more amenable to high throughput optical analysis, as there is less need to focus the optical system for each well. Tolerances of 100 μm can be achieved by these means.

Another variant of a method of and apparatus for manufacturing a substrate plate according to the invention will be explained with reference to FIG. 6. Several features of this variant can also be applied in conjunction with the variant illustrated in FIG. 5 and vice versa. Because of similarities between the variants, parts of the substrate plate shown in FIG. 6 similar to equivalent parts in FIG. 5 have the same reference numeral.

Preferably, the method employs pre-cut substrates 3. The present invention also provides a method of providing pre-cut substrates 3, which can also be employed prior to bonding the substrates 3 in the manner illustrated in FIG. 5. This method involves laser-cutting the substrates 3 from a single sheet of porous substrate. For this purpose, use is advantageously made of a transparent holder (not shown), made e.g. of glass. Preferably, the holder comprises a plurality of collection sites, each adapted in shape to receive a substrate 3 cut from the sheet of substrate material. The sheet of substrate of material is placed on top of the glass holder. When a substrate 3 has been cut using a laser, it drops off and is received in one of the collection sites. The advantage of using a transparent, e.g. glass, holder is that the heat that is released during laser cutting is significantly reduced, because the laser beam will be transmitted through the glass, instead of being absorbed by it. Additionally, an optical quality assessment and quality control procedure can be carried out with the substrates 3 still in the holder.

Preferably, the collection sites are arranged in an array of rows and columns corresponding substantially to at least part of the array of rows and columns in which the wells 2 in the microplate 1 are arranged. Subsequent to the cutting of the substrates 3, the remainder of the sheet of substrate material is removed and the microplate 1 is placed on top, in upside-down orientation. The array of collection sites corresponds substantially to the array of wells 2, i.e. the centres of the substrates 3 received in the collection sites are each substantially aligned with the centres of corresponding wells 2.

Referring to FIG. 6, prior to placement of the microplate 1 on top of the glass holder, the microplate 1 is combined with an insert 30. The insert 30 is adapted to envelope at least parts of side walls of the protrusions of the microplate 1 that form the wells. More particularly, an outer surface 31 of the insert 30 supports the outer wall 13 of the well 2, to prevent it from buckling outwards during thermal bonding. Note that the insert 30 thus forms a guide similar to the guide 27 of FIG. 5. It is observed that the insert 30 may comprise a number of discrete parts, together forming a guide for supporting the wells 2 from the outside.

In addition, the insert 30 comprises one or more overhangs 32, arranged to cover a part of an edge 33 of the microplate protrusions to which the substrates 3 are bonded. The overhangs 32 are complimentary in shape to the substrates 3, i.e. the perimeter of the substrate fits snugly into the overhangs 32. Thus, the overhangs serve to further align the substrates relative to the microplate 1, thus preventing holes at the bottom of the wells 2.

After combining the insert 30, microplate 1 and holder with the substrates 3, the stack formed from them is turned over, so that the substrates lie on top of the microplate 1, as shown in FIG. 6. The glass holder can then be lifted off.

In this position, the wells 2 are supported from the inside by supports 34, having a function similar to the protrusions 25 of the stamp 24 shown in FIG. 5. The supports 34 are arranged in an array of rows and columns corresponding substantially to the array of wells 2, and are each shaped to engagingly fit inside a well 2, such that the inner walls 26 of each well 2 are supported from the inside by the supports 34. In this position, an outer surface 35 of each support 34 is in contact with the inner walls 26. The supports 34 shown in FIG. 6 comprise vacuum channels 36, an optional extra, which help to keep the substrates 3 in position. In addition, each support 34 is positioned in the press on top of a spring 37 or similar resilient means, to help maintain a uniform pressure distribution.

A heated plate 38 is used for the actual bonding in this example. The heated plate 38 comprises cylindrical protruding rims 39. The rims 39 are thus each arranged in a shape, namely a round shape, corresponding to the shape of the perimeter of a substrate (the substrates are circular in this case). Again, the cylinders formed by the protruding rims 39 are arranged in an array of rows and columns corresponding substantially to the array in which the wells 2 are arranged. The heated plate 38 is guided in the apparatus for manufacturing the substrate plate in such a way that the cylinders formed by the protruding rims 39 are centred on the wells 2 during the bonding, as shown in FIG. 6.

The heated plate 38 is heated from above by a heat block 40, through which pressure is also supplied. Heat is conducted to the edges of the substrate 3 through a surface 41 at the distal end of each protruding rim 39, i.e. locally. An advantage of using a separate heated plate 38, is that the heat block 40 may be part of a conventional device for sealing substrate plates. This relatively simple adaptation removes the need for a purpose-built special piece of apparatus. Insulating material 42 covering parts of the surface of the heated plate 38 that are not brought into contact with the substrates 3 increase the efficiency of heat transfer. It also enhances control of the heat supply by the heat block 40. Thus the temperature of the heat block 40, and thus of the heated plate 38 can be controlled in the same defined way as previously explained with reference to FIG. 5.

It is noted that at least the heated plate 38 is left on top of the stack of the microplate 1, substrates 3 and insert 30 during cooling, to ensure that the bond between the substrate 3 and microplate 1 is irreversibly established. After cooling, the insert 30 is removed and the finished substrate plate is separated from the supports 34.

The invention is not limited to the above-described embodiments, which can be varied in a number of ways within the scope of the claims.

1-27. (canceled)

28. A substrate plate, comprising a microplate made of a plastic material, having an array of wells arranged in rows and columns, the bottom of at least one well being provided by a porous substrate, characterized in that each porous substrate is incorporated into the well by means of a thermal bond.

29. The substrate plate according to claim 28, wherein the porous substrates comprise oriented flow-through channels.

30. The substrate plate according to claim 28, wherein each well is formed in a discrete protrusion, projecting from one face of the microplate, a separate porous substrate being bonded to the distal end of each protrusion facing away from the face, in such a manner that the porous substrates are spaced apart from each other.

31. The substrate plate according to claim 28, wherein the porous substrates are made of a metal oxide material.

32. The substrate plate according to claim 31, wherein the porous substrates are made of aluminium oxide.

33. The substrate plate according to claim 28, wherein the plastic material comprises a cyclic olefin copolymer.

34. A method of manufacturing the substrate plate according to claim 28, comprising heating the porous substrates and bringing the microplate and porous substrates into contact with each other.

35. The method according to claim 34, comprising supplying heat to the porous substrates while the microplate is in contact with the porous substrates.

36. The method according to claim 34, comprising pressing the microplate and the porous substrates against each other.

37. The method according to claim 36, comprising cooling the porous substrates while pressing the microplate and the porous substrates against each other.

38. The method according to claim 34, comprising cooling the porous substrates by decreasing the rate at which heat is supplied to the porous substrates in a controlled manner.

39. The method according to claim 34, comprising arranging a plurality of porous substrates in an array of rows and columns, corresponding substantially to at least part of the array of rows and columns in which the wells in the microplate are arranged, bringing the microplate and array of porous substrates into alignment in such a manner that each porous substrate is aligned opposite the bottom of a well, and bringing the microplate into contact with the porous substrates in such a manner that each porous substrate closes off the bottom of one well.

40. The method according to claim 39, comprising cutting the substrates from a sheet of porous substrate material.

41. The method according to claim 40, wherein the step of cutting the substrates from the sheet of porous substrate material comprises placing the sheet of substrate material in a holder, comprising a plurality of collection sites for receiving substrates cut from the sheet of porous substrate material, the collection sites being arranged in an array of rows and columns corresponding substantially to at least part of the array of rows and column in which the wells in the microplate are arranged, wherein the step of arranging the plurality of porous substrates comprises receiving the porous substrates cut from the sheet of porous substrate material in the collection sites.

42. The method according to claim 34, comprising providing a sheet of porous substrate material comprising the substrates, bonding the sheet to the microplate, and removing all porous substrate material interconnecting the porous substrates.

43. The method according to claim 34, comprising bonding a microplate in which each well is formed in one of an array of spaced protrusions, arranged in rows and columns and projecting from one face of the microplate, wherein each porous substrate is bonded to the distal end of each protrusion facing away from the face, the method comprising mounting the microplate in a guide adapted to envelope at least parts of side walls connecting the face to the distal end of a corresponding one of the protrusions, such that at least part of a protrusion is supported by the guide.

44. The method according to claim 34, comprising pressing the microplate against the porous substrates by applying a support against the microplate, comprising an array of support protrusions arranged in rows and columns and corresponding substantially to the array of wells, each support protrusion being shaped to engagingly fit inside the well, such that walls of each well are supported from inside the well by the support protrusions, when inserted into the wells.

45. A system for conducting bioassays, comprising a substrate plate with a number of wells, and an incubation device for holding the plate, characterized in that the substrate plate comprises a microplate with an array of wells arranged in rows and columns, wherein the bottom of each well is a porous microarray substrate, wherein the incubation device comprises an incubation chamber for holding the microplate and a cover for sealing the incubation chamber, said incubation device having a heat block with an array of openings, each opening adapted to receive a well of the microplate, wherein a sealing gasket is provided for individually sealing each well of the microplate, and in that the system comprises a substrate plate according to claim 28.

46. An apparatus for manufacturing a substrate plate according to claim 28, comprising a heating device for heating the porous substrates and a press for pressing the microplate and the porous substrates against each other.

47. The apparatus according to claim 46, wherein the press comprises a heated plate, the heated plate comprising a plurality of protruding rims, each arranged in a shape corresponding to a perimeter of a porous substrate and substantially centered on a well of the microplate, the rims being arranged to contact a part of a face of a porous substrate facing away from the microplate near the perimeter of the porous substrate.

48. The apparatus according to claim 46, suitable for manufacturing a substrate plate in which the porous substrates lie substantially in a plane, wherein the heating device comprises a heating surface arranged to contact a face of the porous substrates facing away from the microplate.

49. The apparatus according to claims 46, further comprising a controller for decreasing the rate at which heat is supplied to the porous substrates in a controlled manner.

50. The apparatus according to claim 46, wherein the press comprises a support to be applied against the microplate and a guidance mechanism for aligning the support relative to the porous substrates in a plane perpendicular to the direction of pressing.

51. The apparatus according to claim 50, wherein the guidance mechanism comprises spacing means for limiting the movement of the support in the direction of pressing to a pre-determined distance from the substrates.

52. The apparatus according to claim 46, wherein the press comprises a support to be applied against the microplate and the support comprises an array of support protrusions arranged in rows and columns and corresponding substantially to the array of wells, each support protrusion being shaped to engagingly fit inside the well, such that walls of each well are supported from inside by the support protrusions, when inserted into the wells.

53. The apparatus according to claim 46, suitable for bonding a microplate in which each well is formed in one of an array of spaced protrusions, arranged in rows and columns and projecting from one face of the microplate, and arranged to bond each porous substrate to the distal end of each protrusion facing away from the face, which apparatus comprises a guide for mounting the microplate, adapted to envelope at least parts of side walls connecting the face to the distal end of a corresponding one of the protrusions, such that at least part of a protrusion is supported by the guide.

54. The apparatus according to claim 53, wherein each guide comprises one or more overhangs, arranged to cover a part of a surface on the distal end of at least one protrusion to which a porous substrate is to be bonded, the covered part being complementary in shape to a porous substrate.
